(19) United States
(12) Patent Application Publication
(10) Pub. No.: US 2007/0007785 A1
(43) Pub. Date: Jan. 11, 2007

(54) Cargo deck for truck box

(75) Inventor: Mark Thygesen, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Marathon Marine Manufacturing (1996) Ltd., Edmonton (CA)

(21) Appl. No.: 11/294,189

(22) Filed: Dec. 5, 2005

(30) Foreign Application Priority Data
Jul. 8, 2005 (CA) 2,512,385

(51) Int. Cl. B60R 7/00

(52) U.S. Cl. 296/37.1

(57) ABSTRACT

A cargo deck, including a deck substrate supporting structural frame having a front end, a rear end, and opposed sides. The structural frame is formed from a least two “H” section cross-members consisting of elongated square tubing having opposed pairs of parallel flanges which form an “H” shaped cross-section, receiver channels being defined by the opposed pairs of parallel flanges. Longitudinally oriented square connective tubing has opposed ends secured within the receiver channels of the “H” section cross-members. Longitudinally oriented “Z” section beams are secured to an underside of the square connective tubing and the “H” section cross-members. An underlying support structure is secured to the “Z” section beams. This cargo deck configuration requires less welding, and allows the cargo deck assembly to be reduced for shipping.

### FIELD OF THE INVENTION

The present invention relates to a cargo deck structure that fits in a truck box of a pick up truck

### BACKGROUND OF THE INVENTION

Cargo decks are used to facilitate transporting all terrain vehicles, snowmobiles or water craft, while still leaving underlying space in the truck box available for storage of accessories and gear. At the present time cargo decks are made from square tubing welded together to form a deck support structure.

### SUMMARY OF THE INVENTION

According to the present invention there is provided a cargo deck, including a deck substrate supporting structural frame having a front end, a rear end, and opposed sides. The structural frame is formed from at least two “H” section cross-members consisting of elongated square tubing having opposed pairs of parallel flanges which form an “H” shaped cross-section, receiver channels being defined by the opposed pairs of parallel flanges, and longitudinally oriented square connective tubing having opposed ends secured within the receiver channels of the “H” section cross-members. The structural frame is also formed from a pair of underlying longitudinally oriented “Z” section beams each “Z” section beam having a substantially planar main body with opposed ends, a first face, a second face opposed to the first face, a first edge and a second edge, a first flange extending substantially perpendicularly from the first face at the first edge, a second flange extending substantially perpendicularly from the second face at the second edge. The main body, first flange and second flange form a “Z” shaped cross-section, the first flange being secured to an underside of the square connective tubing and the “H” section cross-members. The structural frame is also formed from an underlying support structure secured to the “Z” section beams, such as two front legs and two rear legs.

Other aspects of the invention will be apparent from the description of the preferred embodiment and the claims.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is an upper perspective view of a cargo deck constructed in accordance with the teachings of the present invention. FIG. 2 is a perspective view of the “H” section cross-members used in the construction of the cargo deck illustrated in FIG. 1.

FIG. 3 is a detailed perspective view of the front end of the cargo deck illustrated in FIG. 1.

FIG. 4 is a perspective view of the “Z” section beam used in the construction of the cargo deck illustrated in FIG. 1.

FIG. 5 is a detailed lower perspective view of the front leg installed on the structural frame of the cargo deck illustrated in FIG. 1.

FIG. 6 is a detailed lower perspective view of the adjustable rear leg installed on the structural frame of the cargo deck illustrated in FIG. 1.

FIG. 7 is a lower perspective view of the cargo deck illustrated in FIG. 1, with the structural frame prepared for installation in a truck with a short box.

FIG. 8 is a lower perspective view of the cargo deck illustrated in FIG. 1, with the structural frame prepared for installation in a truck with a long box.

FIG. 9 is a detailed perspective view of an extendible loading ramp connected to the rear end of the cargo deck illustrated in FIG. 1.

FIG. 10 is a perspective view of the extendible loading ramp illustrated in FIG. 9.

FIG. 11 is a perspective view of the extendible loading ramp illustrated in FIG. 9, being installed under the structural frame of the cargo deck illustrated in FIG. 1.

FIG. 12 is a perspective view of the loading ramp illustrated in FIG. 1, in an orientation adapted to load ATVs.

FIG. 13 is a perspective view of the loading ramp illustrated in FIG. 1, in an orientation adapted to load snowmobiles.

FIG. 14 is a perspective view of the cargo deck illustrated in FIG. 1, with sides extended.

FIG. 15 is a perspective view of the extendible side illustrated in FIG. 14.

### DETAILED DESCRIPTION OF THE PREFERRED EMBODIMENT

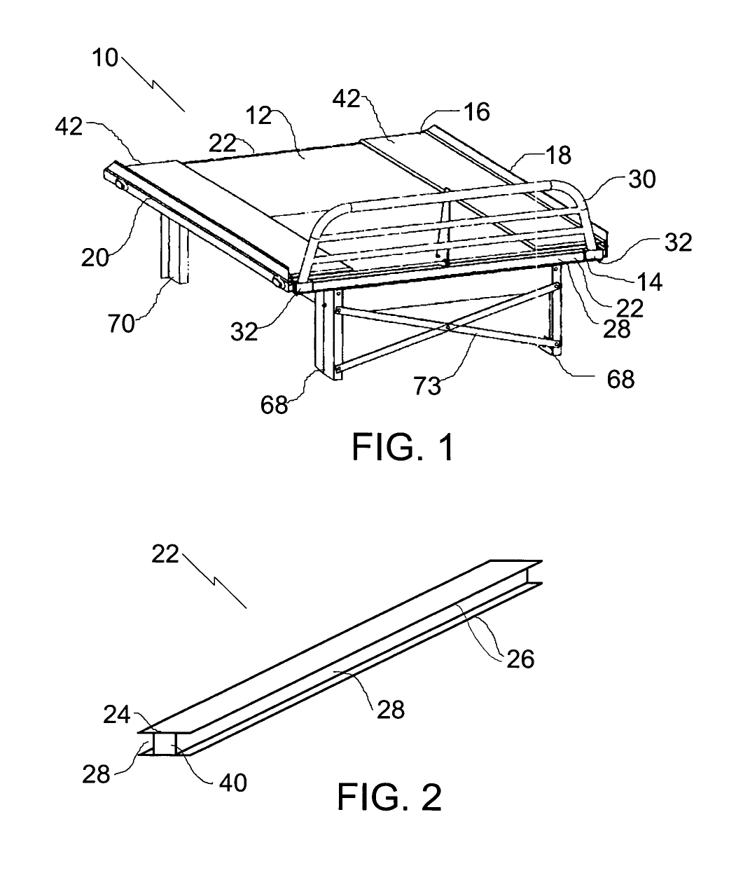

The preferred embodiment, a cargo deck generally identified by reference numeral 10, will now be described with reference to FIG. 1 through 15.

Structure and Relationship of Parts:

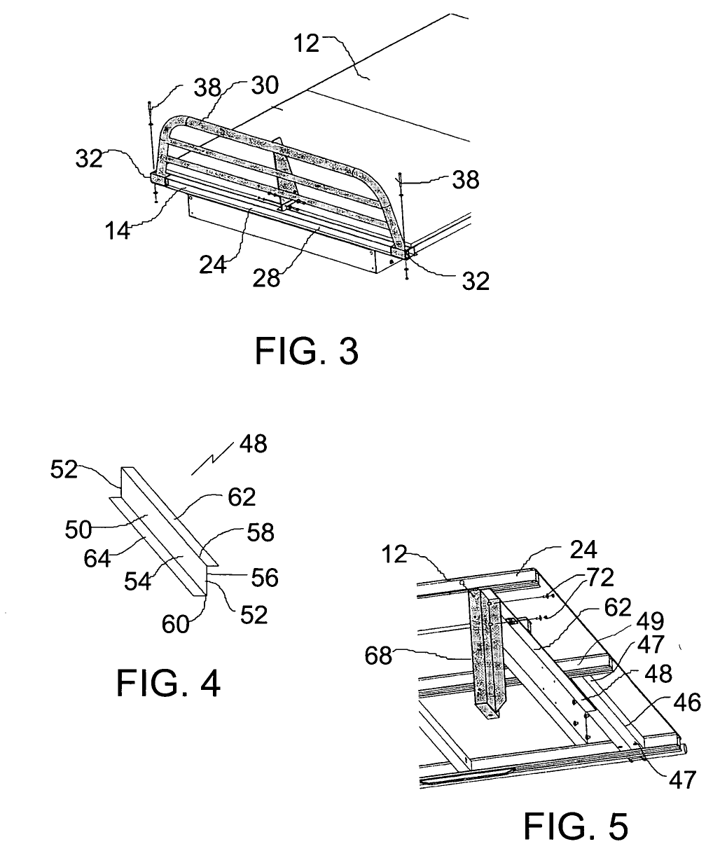

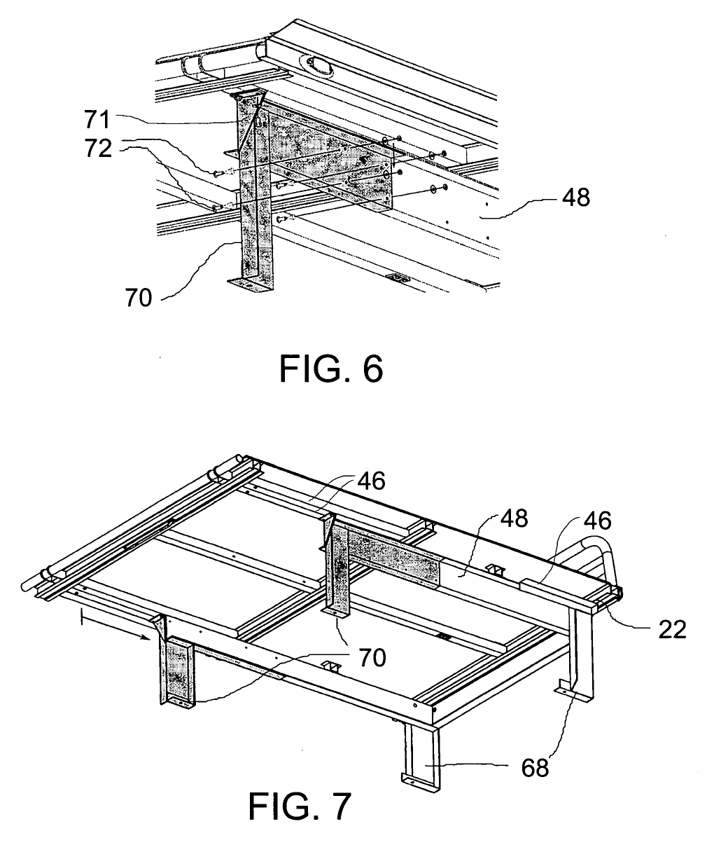

Referring now to FIG. 1, there is shown cargo deck 10, including a deck substrate supporting structural frame 12 having a front end 14, a rear end 16, and opposed sides 18 and 20. Structural frame 12 is formed from at least two “H” section cross-members 22. Referring to FIG. 2, “H” section cross-members 22 consist of elongated square tubing 24 that have opposed pairs of parallel flanges 26 which form an “H” shaped cross-section. “H” section cross-members 22 also include receiver channels 28 that are defined by the opposed pairs of parallel flanges 26. Referring to FIG. 3, a modular headache rack 30 has channel engaging members 32 which engage receiver channels 28 of one “H” section cross-members 22 at front end 14 of structural frame 12. Channel engaging members 36 are detachably secured by fasteners 38 to “H” section cross-member 22. Referring to FIG. 5, there is longitudinally oriented square connective tubing 46 having opposed ends 47 secured within receiver channels 28 of “H” section cross-members 22. Also included, referring to FIG. 8, is a pair of underlying longitudinally oriented “Z” section beams 48. Referring to FIG. 4, each “Z” section beam 48 has a substantially planar main-body 50 with opposed ends 52, a first face 54, a second face 56 opposed to first face 54, a first edge 58 and a second edge 60. A first flange 62 extends substantially perpendicularly from first face 54 at first edge 58. A second flange 64 extends substantially perpendicularly from second face 56 at second edge 60. As can be seen, main body 50, first flange 62 and second flange 64 form a “Z” shaped cross-section. Referring to FIG. 5, first flange 62 is secured to an underside of square connective tubing 46 and “H” section cross-members 22. Referring to FIG. 7 and 8, there is also an underlying support structure secured to “Z” section beams 48 in the form of two front legs 68 and two rear legs 70. Each leg may be made from truncated “Z” section beams, and can be detachably secured to “Z” section beams 48 by fasteners 72. A rear leg sway brace 71 in the form of a triangle is included to stabilize legs 70. Front leg 68 is shown secured in FIG. 5 and rear leg 70 is shown secured in FIG. 6. Referring to FIG. 7, connective tubing 46 is doubled up at the rear of cargo deck 10 positioned above “Z” section beam and rear leg sway brace 71, and one connective tubing 46 is at the front of cargo deck 10, positioned above “Z” section beam 48. Referring to FIGS. 7 and 8, rear legs are attachable in different positions, depending on the size of the box of the truck to be used. The short box arrangement is shown in FIG. 7, and the long box arrangement is shown in FIG. 8. Referring to FIG. 1, cross-bracing 73 extends between front legs 68.

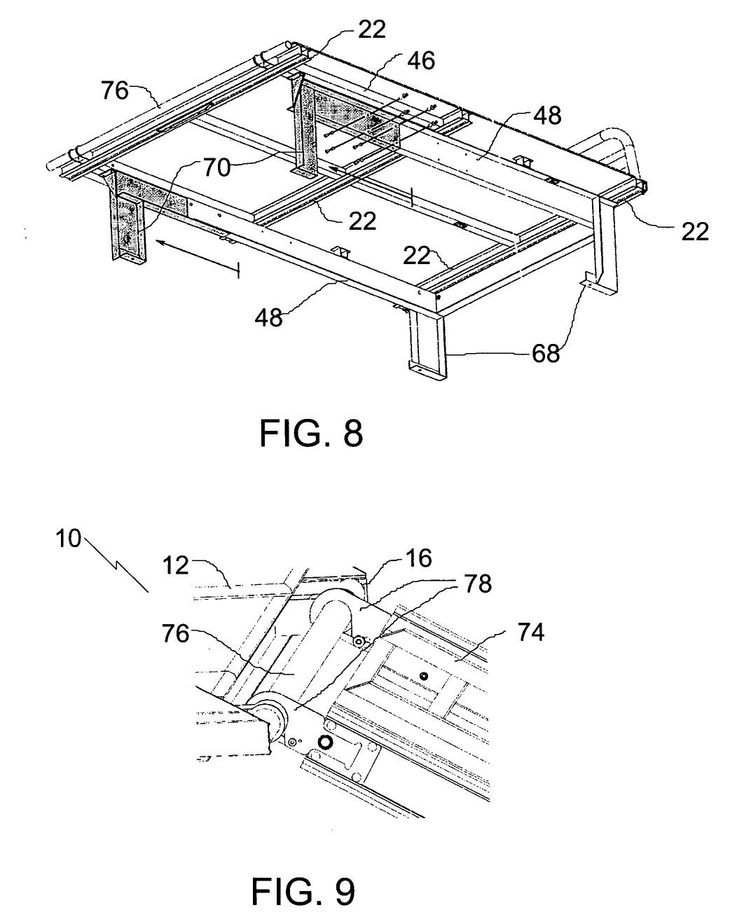

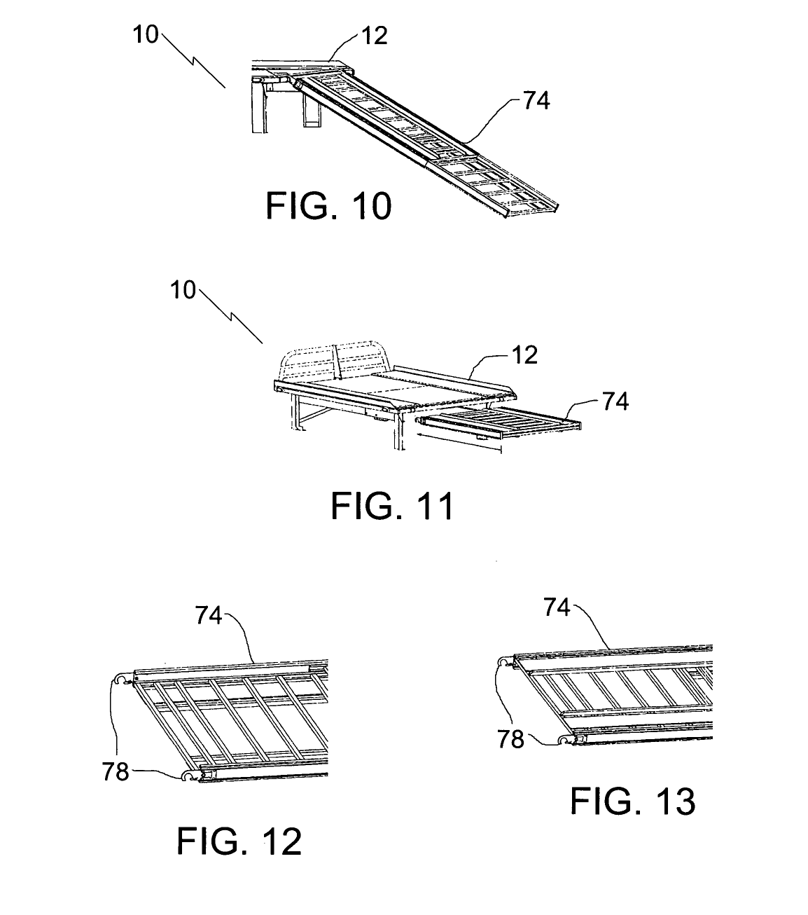

Referring to FIG. 9, a loading ramp 74 is detachably secured to rear end 16 of structural frame 12, with at least one cylindrical member 76 secured to rear end 16 of structural frame 12 to facilitate attachment of loading ramp 74 by means of hooks 78 which engage cylindrical member 76. Alternatively (not shown), loading ramp 74 may also be secured to side 18 or 20 to allow for side loading of deck 10. Loading ramp 74 may also be telescopically extendible, as shown in FIG. 10, and, referring to FIG. 1, may be adapted to be stored under structural frame 12. Finally, referring to FIG. 12 and FIG. 13, loading ramp 74 may be reversible such that one side is convenient for loading ATVs (shown in FIG. 12), and the other side is convenient for loading snowmobiles (shown in FIG. 13). This is made possible by making hooks 78 removable and reversible as well.

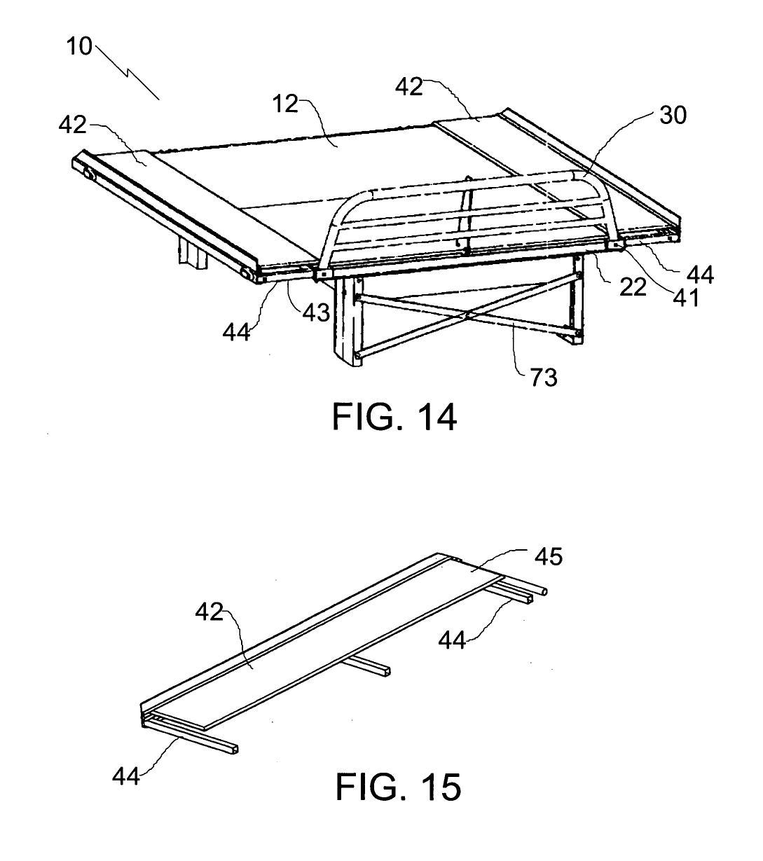

Referring now to FIG. 14, cargo deck 10 may also have extendible sides 42 to provide additional cargo space and to reduce the size of cargo deck 10 for shipping.

Referring to FIG. 2, “H” section cross-members 22 have a tubular sidewall 38 that define an interior bore 40. Referring to FIG. 15, side extensions 42 are also provided, where each side extension 42 have protruding male members 44 that are received within interior bore 40 of “H” section cross-members 22 in mating relation. The rear end 45 of extendible sides 42 are tapered for ease of loading. Referring to FIG. 14, extendible sides 42 may be secured in the desired position using pin fasteners 41 and are extended and retracted along bearings 43 such as UHMW bearings.

Operation:

The use and operation of cargo deck 10 will now be discussed with reference to FIGS. 1 through 15. Referring now to FIG. 8, “H” section cross members 22 are attached to structural frame 12. Square connective tubing 46 is then attached to “H” section cross members 22, and “Z” section beams 48 are attached to both “H” section cross members 22 and square connective tubing 46. Front legs 68 and rear legs 70 are attached to “Z” section beams 48, either in the short-box configuration shown in FIG. 7, or the long-box configuration as shown in FIG. 8. Referring to FIG. 1, cross-bracing 73 is then installed between front legs 68, extendible sides 42 are installed, and headache rack 30 is installed in “H” section cross members 22, each as discussed above. Referring to FIG. 6, rear leg sway bracing 71 is tied into connective tubing 46 for additional support. Referring to FIG. 9, when cargo deck 10 is to be loaded or unloaded, loading ramp 74 is secured to cylindrical member 76 by hooks 78, and lowered to the ground by extending ramp 74 if required, as shown in FIG. 10. Hooks 78 may be removed and reversed, depending on what is being loaded on cargo ramp 74. Referring now to FIG. 11, once cargo deck 10 has been loaded or unloaded, loading ramp 74 is then stored under structural frame 12. Referring to FIG. 14, if more space is required on cargo deck 10, extendible sides 42 may be extended.

Advantages

Previously, simple square tubing was used in structural frames. The “H” section cross members provides a more secure hold when other parts are connected to the member because of the flanges above and below the connecting part. In addition, less welding is required, and therefore less distortion of the assembly. The “Z” section beams are advantageous because it allows some flex in the structure, reducing strain on welded joints and forms a channel carrier for the extendible ramp.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A cargo deck, comprising:
a deck substrate supporting structural frame having a front end, a rear end, and opposed sides, the structural frame being formed from:
at least two “H” section cross-members consisting of elongated square tubing having opposed pairs of parallel flanges which form an “H” shaped cross-section, receiver channels being defined by the opposed pairs of parallel flanges;
longitudinally oriented square connective tubing having opposed ends secured within the receiver channels of the “H” section cross-members;
a pair of underlying longitudinally oriented “Z” section beams each “Z” section beam having a substantially planar main body with opposed ends, a first face, a second face opposed to the first face, a first edge and a second edge, a first flange extending substantially perpendicularly from the first face at the first edge, a second flange extending substantially perpendicularly from the second face at the second edge, the main body, first flange and second flange forming a “Z” shaped cross-section, the first flange being secured to an underside of the square connective tubing and the “H” section cross-members; and
an underlying support structure secured to the “Z” section beams.

2. The cargo deck as defined in claim 1, wherein the underlying support structure is in the form of two front legs and two rear legs.

3. The cargo deck as defined in claim 2, wherein each of the legs are made from truncated “Z” section beams.

4. The cargo deck as defined in claim 3, wherein the each of legs are detachably secured to the “Z” section beams by fasteners.

5. The cargo deck as defined in claim 2, wherein cross-bracing extends between the front legs.

6. The cargo deck as defined in claim 1, wherein a modular headache rack has channel engaging members which engages the receiver channels of one the “H” section cross- members at the front end of the structural frame, the channel engaging members being detachably secured by fasteners to the “H” section cross-member.

7. The cargo deck as defined in claim 1, wherein a loading ramp is detachably secured to one of the sides of the structural frame, the rear end of the structural frame, or side extensions of the loading ramp.

8. The cargo deck as defined in claim 7, wherein at least one cylindrical member is secured to the rear end of the structural frame, thereby facilitating attachment of a loading ramp by means of hooks which engage the at least one cylindrical member.

9. The cargo deck as defined in claim 7, wherein the loading ramp is telescopically extendible.

10. The cargo deck as defined in claim 1, wherein the “H” section cross-members having a tubular sidewall defining an interior bore, side extensions are provided, each side extension having protruding male members that are received within the interior bore of the “H” section cross-members in mating relation.
